(19) United States
(12) Patent Application Publication
(10) Pub. No.: US 2012/0158867 A1
(43) Pub. Date: Jun. 21, 2012

(54) CLOUD MESSAGE TRANSFER APPARATUS TO REDUCE NON-DELIVERY REPORTS

(75) Inventor: ZACHARY LEVOW, Camas, WA (US)

(73) Assignee: BARRACUDA NETWORKS, INC, Campbell, CA (US)

(21) Appl. No.: 12/973,727

(22) Filed: Dec. 20, 2010

(51) Int. Cl. G06F 15/16

(52) U.S. Cl. 709/206

(57) ABSTRACT

Duplicate deliveries of email messages are prevented when a transient failure prevents delivery to some of a plurality of intended recipients but delivery to an other one or more of the intended recipients is successful. After receiving a list of recipients, an email body, and an “end of data” sequence, but prior to responding to the “end of data” sequence, an email server determines a transient failure reply code when any one of the address mailboxes of intended recipients is not available. A message-memorandum, such as the globally unique message-id and the address of one or more successful recipients is stored into a memorandum store. A subsequent transmission of the corresponding message will only be delivered to recipients who have not previously received it. Using this invention, the receiving/relay system would persistently track which recipients were allowed or refused by some unique characteristic of the message, such as internet message ID or a checksum of the distinct portions of the message/envelope that are unlikely to change (e.g. sender, recipients, body). Once a message has been identified as one that has been previously partially deferred, the recipients that were previously allowed would be ignored and delivery would be attempted only to the recipients that had not previously been allowed.

### RELATED APPLICATIONS

Not Applicable.

### BACKGROUND

1. Field of the Invention

The field of the invention relates to electronic mail systems and methods. In particular, transfer of a message intended for, but not successfully delivered to all of a plurality of recipients.

2. Background of the Prior Art

The present invention is distinguished from conventional solutions for identifying and removing spam such as U.S. Pat. No. 6,732,157.

The present invention is distinguished from conventional solutions for avoiding duplicate messages such as 7430580, 7831676, and 20100274857.

In a conventional system, when delivery to at least one of the intended recipients is successful but delivery to at least one other of the intended recipients is not successful, the mail system is expected to manage a mail queue and attempt to retry. The design of the simple mail transfer protocol (SMTP) system effectively requires the server to manage a mail delivery queue and send a non-delivery report after several attempts. This is because a single mail transaction may specify multiple recipients and the final “.” of the DATA command may return only one reply code, to indicate the status of the entire transaction. If, for example, a server is given a transaction for two recipients, delivery to the first succeeds, and delivery to the second encounters a temporary failure condition, there is no mechanism to inform the client of the detailed situation. The server must either queue the delayed message and later attempt to deliver it to the second recipient or indicate failure for both which results in duplicate delivery to the first recipient upon retransmission. This queuing requirement is beneficial in the situation for which SMTP was originally designed: store-and-forward relay of mail between networked hosts. But things have changed.

According to rfc0821 (Postel August 1982):
“Special mention is needed of the response and action required when the processing following the end of mail data indication is partially successful. This could arise if after accepting several recipients and the mail data, the receiver-SMTP finds that the mail data can be successfully delivered to some of the recipients, but it cannot be to others (for example, due to mailbox space allocation problems). In such a situation, the response to the DATA command must be an OK reply. But, the receiver-SMTP must compose and send an “undeliverable mail” notification message to the originator of the message. Either a single notification which lists all of the recipients that failed to get the message, or separate notification messages must be sent for each failed recipient . . . . All undeliverable mail notification messages are sent using the MAIL command (even if they result from processing a SEND, SOML, or SAML command).”

Appendix E of RFC 821 provides as follows:
“Theory of Reply Codes
The three digits of the reply each have a special significance. The first digit denotes whether the response is good, bad or incomplete. An unsophisticated sender-SMTP will be able to determine its next action (proceed as planned, redo, retrench, etc.) by simply examining this first digit. A sender-SMTP that wants to know approximately what kind of error occurred (e.g., mail system error, command syntax error) may examine the second digit, reserving the third digit for the finest gradation of information.
There are five values for the first digit of the reply code:
   1yz Positive Preliminary reply
      The command has been accepted, but the requested action is being held in abeyance, pending confirmation of the information in this reply. The sender-SMTP should send another command specifying whether to continue or abort the action.
      [Note: SMTP does not have any commands that allow this type of reply, and so does not have the continue or abort commands.]
   2yz Positive Completion reply
      The requested action has been successfully completed. A new request may be initiated.
   3yz Positive Intermediate reply
      The command has been accepted, but the requested action is being held in abeyance, pending receipt of further information. The sender-SMTP should send another command specifying this information. This reply is used in command sequence groups.
   4yz Transient Negative Completion reply
      The command was not accepted and the requested action did not occur. However, the error condition is temporary and the action may be requested again. The sender should return to the beginning of the command sequence (if any). It is difficult to assign a meaning to “transient” when two different sites (receiver- and sender-SMTPs) must agree on the interpretation. Each reply in this category might have a different time value, but the sender-SMTP is encouraged to try again. A rule of thumb to determine if a reply fits into the 4yz or the 5yz category (see below) is that replies are 4yz if they can be repeated without any change in command form or in properties of the sender or receiver. (E.g., the command is repeated identically and the receiver does not put up a new implementation.)
   5yz Permanent Negative Completion reply
      The command was not accepted and the requested action did not occur. The sender-SMTP is discouraged from repeating the exact request (in the same sequence). Even some “permanent” error conditions can be corrected, so the human user may want to direct the sender-SMTP to reinitiate the command sequence by direct action at some point in the future (e.g., after the spelling has been changed, or the user has altered the account status).
   The second digit encodes responses in specific categories:
x0z Syntax—These replies refer to syntax errors, syntactically correct commands that don't fit any functional category, and unimplemented or superfluous commands.
x1z Information—These are replies to requests for information, such as status or help.
x2z Connections—These are replies referring to the transmission channel.
x3z Unspecified as yet.
x4z Unspecified as yet.
x5z Mail system—These replies indicate the status of the receiver mail system vis-a-vis the requested transfer or other mail system action.
The third digit gives a finer gradation of meaning in each category specified by the second digit . . . .
For example, a command such as NOOP whose successful execution does not offer the sender-SMTP any new information will return a 250 reply. The response is 502 when the command requests an unimplemented non-site-specific action. A refinement of that is the 504 reply for a command that is implemented, but that requests an unimplemented parameter.
The reply text may be longer than a single line; in these cases the complete text must be marked so the sender-SMTP knows when it can stop reading the reply. This requires a special format to indicate a multiple line reply.
The format for multiline replies requires that every line, except the last, begin with the reply code, followed immediately by a hyphen, “-” (also known as minus), followed by text. The last line will begin with the reply code, followed immediately by <SP>, optionally some text, and <CRLF>.
   For example:
      123-First line
      123-Second line
      123-234 text beginning with numbers 123 The last line
In many cases the sender-SMTP then simply needs to search for the reply code followed by <SP> at the beginning of a line, and ignore all preceding lines. In a few cases, there is important data for the sender in the reply “text”. The sender will know these cases from the current context.”

It is also known that the enhanced SMTP protocol for electronic mail allows for delivery status notification (DSN) to describe the delivery status for exactly one message. However, a mail transfer agent (MTA) MAY report on the delivery status for several recipients of the same message in a single DSN. Due to the nature of the mail transport system (where responsibility for delivery of a message to its recipients may be split among several MTAs, and delivery to any particular recipient may be delayed), multiple DSNs may still be issued in response to a single message submission. As a result a single message to multiple recipients may result in multiple negative delivery reports.

In contemporary implementations negative delivery reports (NDR) practice has become deprecated, due to spam. Most of the NDRs in the world are generated in response to spam messages and are sent to a forged sender that either does not exist or was not the actual sender, so they result in anxiety for the innocent forged senders. The effect of the proliferation of SPAM messages with forged return addresses is that DSN failure messages are too numerous to provide useful information.

### DEFINITIONS

Definitions: consistent with RFC 821 the following is used
end of mail data indication:
   A special sequence of characters that indicates the end of the mail data. In particular, the five characters carriage return, line feed, period, carriage return, line feed, in that order.
   reply:
   A reply is an acknowledgment (positive or negative) sent from receiver to sender via the transmission channel in response to a command. The general form of a reply is a completion code (including error codes) followed by a text string. The codes are for use by programs and the text is usually intended for human users.

A conventional SMTP or ESMTP standard compliant server must either reject or accept an email even when it is not determined yet that all recipients are operational. If it rejects, then the sender is likely to retry for all recipients, potentially duplicating transmission for those that were successful on first try. If it accepts, then it has the responsibility of continuing to try until it gives up or hits a permanent error and is expected to initiate a bounce message which may be ignored. The present invention provides a solution.

### SUMMARY

The present invention stores recipients and characteristics of messages intended for a plurality of recipients but which were not successfully delivered to at least one of the intended recipients. A subsequent receipt of substantially the same message is determined by reading the stored characteristics of previously received messages and duplication of transmission is avoided to previously successful recipients. Conventionally success and failure codes are transmitted to the message sender when delivery to all of the intended recipients is either successful or fails. Unconventionally, the invention determines when the delivery status is mixed i.e. delivery at least one of the intended recipients is successful and delivery of at least one other of the intended recipients is not successful, whereupon the response to the end of data sequence of the DATA command is determined to be of the type of temporary failure e.g. 4yz where y and z are positions for numerical codes.

The apparatus, system, and method comprises in one embodiment:
a circuit to receive electronic messages intended for a plurality of recipients and to respond to an end of mail data indication with a type of SMTP reply code when delivery status was mixed, coupled to
a circuit to determine a delivery status of mixed when delivery was successful to at least one of the intended recipients and was not successful to at least one other of the intended recipients, coupled to
a circuit to store recipients and characteristics of messages with a mixed delivery status into a message-memorandum store; the circuit to determine delivery status further coupled to
a circuit to attempt transmission to intended recipients of a message not having previously received the message; coupled to
a circuit for determining if an intended recipient had previously received a substantially similar message by reading recipients and characteristics from the message-memorandum store;
the apparatus comprising a message-memorandum store comprising a message characteristic store and a message recipient store coupled to the circuits to read and store recipients and characteristics of a message which was successfully delivered to at least one of the intended recipients and was not successfully delivered to at least one other of the intended recipients.

An other embodiment comprises an apparatus comprising
a message-memorandum store,
comprising characteristic store for each message, and
a list store of recipients who have successfully received each message;
   a circuit to receive electronic messages intended for a plurality of intended recipients,
which includes a circuit to transmit a reply code
after receiving the end of mail data indication;
   a circuit to determine if a message is substantially similar to a previously received message whose recipients are in the list store,
      coupled to the circuit to receive electronic messages and coupled to the message-memorandum store;
   a circuit to attempt transmission to an intended recipient not in the list store of a message substantially similar to a previously received message whose recipients are in the list store,
      coupled to a circuit to determine if an intended recipient is in the list store;
   a circuit to determine a message delivery status of mixed status if a message delivery to a plurality of intended recipients has at least one success status with respect to the intended recipients and at least one failure status with respect to the intended recipients,
      coupled to the circuit to attempt transmission and
      coupled to the circuit to transmit a reply code;
   a circuit to store characteristics of each message which was intended to a plurality of recipients and was delivered successfully to at least one recipient and was not delivered successfully to at least one other recipient,
      coupled to the characteristic store, and
      coupled to the circuit to determine message delivery status of mixed status;
   a circuit to store into a list store the intended recipients of a message with mixed status to whom the delivery was successful,
      coupled to the list store, and
      coupled to the circuit to determine message delivery status.

### BRIEF DESCRIPTION OF DRAWINGS

FIGS. 1 and 2 are block diagrams of an exemplary functional system incorporating a cloud mail transmission processing apparatus.

FIG. 3 is a logic table illustrating determination of reply codes from combinations of delivery status and illustrating exemplary message characteristics. FIGS. 4-6 are block diagrams of an embodiment of the apparatus.

### DETAILED DISCLOSURE OF EMBODIMENTS

The present invention is distinguished from solutions for identifying and removing spam by its message-memorandum store for recording who has already received substantially the same message. The present invention is distinguished from solutions for identifying duplicate messages by its circuit and method for determining a delivery status of mixed and which results in transmitting a reply code which encourages automatic retry.

In the following disclosure, failure and failure type reply codes include Permanent Negative Completion reply and Transient Negative Completion reply.

The terms end of data, end of mail data, end of mail data indication, and end of data sequence are used equivalently.

A success type of reply code is equivalent to Positive Completion reply.

In one embodiment of the invention, an apparatus comprises:
a network interface communicatively coupled to
an email message-memorandum recipient, and delivery status store, coupled to
a plurality of email message recipient mailboxes, coupled to a circuit configured to perform the commands of Cloud Mail Transmission Processing; the circuit further configured to perform checking of email delivery status to each of a plurality of recipients, combining delivery status to a plurality of intended recipients into a single reply code, and providing the CMTP combined reply code to a sender of an email addressed to the plurality of recipients.

In another embodiment of the invention, a system comprises a network interface and a processor communicatively coupled to computer-readable media, the processor configured to
determine if a message has been successfully delivered to all of a plurality of recipients,
determine if delivery of the message to one or more of the recipients has been deferred, and
determine and transmit a reply code to the sender in response to an end of mail data indication.

In another embodiment of the invention, a computer-readable storage device is tangibly encoded with computer executable instructions to
receive simple mail transfer protocol commands,
check a data store for delivery status of a message-id to each of a plurality of recipients,
deliver the message only to available recipients which have not yet received a substantially similar message,
update a data store with the current status of message delivery, and
respond to an “end of data” sequence with a reply code derived from the combination of message delivery status of each recipient. In an embodiment the reply code is of the type success when delivery to all of the recipients have been successful and of the type failure when delivery to some of the recipients has been successful and delivery to some other of the recipients has not been successful. In an embodiment the reply code is followed by a list of the recipients to whom delivery was successful. In an embodiment the reply code is followed by a list of the intended recipients to whom delivery was not successful. In an embodiment a reply code for a type failure is 4yz i.e. beginning with a numeral four and followed by two other numerals.

In one embodiment, a computer-implemented method for receiving electronic mail transmitted to a plurality of recipients comprises the steps following:
receiving at least a first recipient and a second recipient;
receiving DATA and an “end of data” sequence;
determining the email delivery status for each recipient from among the following:
   success,
   persistent transient failure, and
   permanent failure;
transmitting a persistent transient failure code in response to the “end of data” sequence when the email delivery status for the respective recipients are any combination of success and persistent transient failure;
transmitting a permanent failure code in response to the “end of data” sequence when the email status for the respective recipients are success and permanent failure; and
transmitting a success code in response to the “end of data” sequence when the email delivery status for the respective recipients are uniformly successful.

In an embodiment, the method further comprises the steps: transmitting a persistent transient failure code in response to the “end of data” sequence when the email status for the respective recipients are persistent transient failure and permanent failure.

In an other embodiment, a method for operating an email server comprises the steps:
receiving a plurality of recipients in an SMTP mail session;
receiving DATA and an “end of data” sequence;
determining, prior to closing the DATA command dialog, the email delivery status for each recipient from among the following:
1. Success,
2. Persistent transient failure, and
3. Permanent failure;
   transmitting a persistent transient failure reply code in response to the “end of data” sequence when the email status for the recipients comprise no permanent failures and at least one persistent transient failure; and
   transmitting a success code in response to the “end of data” sequence when the email status for the recipients are selected from the following: success and not any other status.

In an embodiment, the method further comprises the steps: transmitting a persistent transient failure code in response to the “end of data” sequence when the email status for the recipients are at least one persistent transient failure and at least one permanent failure.

In an embodiment, the method further comprises the steps: storing at least a globally unique email identifier and delivery status for each recipient for each email for which the server determines a persistent transient failure status at the “end of DATA” sequence.

In an embodiment, the method further comprises the steps:
receiving a MAIL command, a message-id, and at least one RCPT,
determining if the recipient does not have a record of delivery success for the message-id, and
transmitting the message to the recipient if the message has not been successfully transmitted to the recipient.

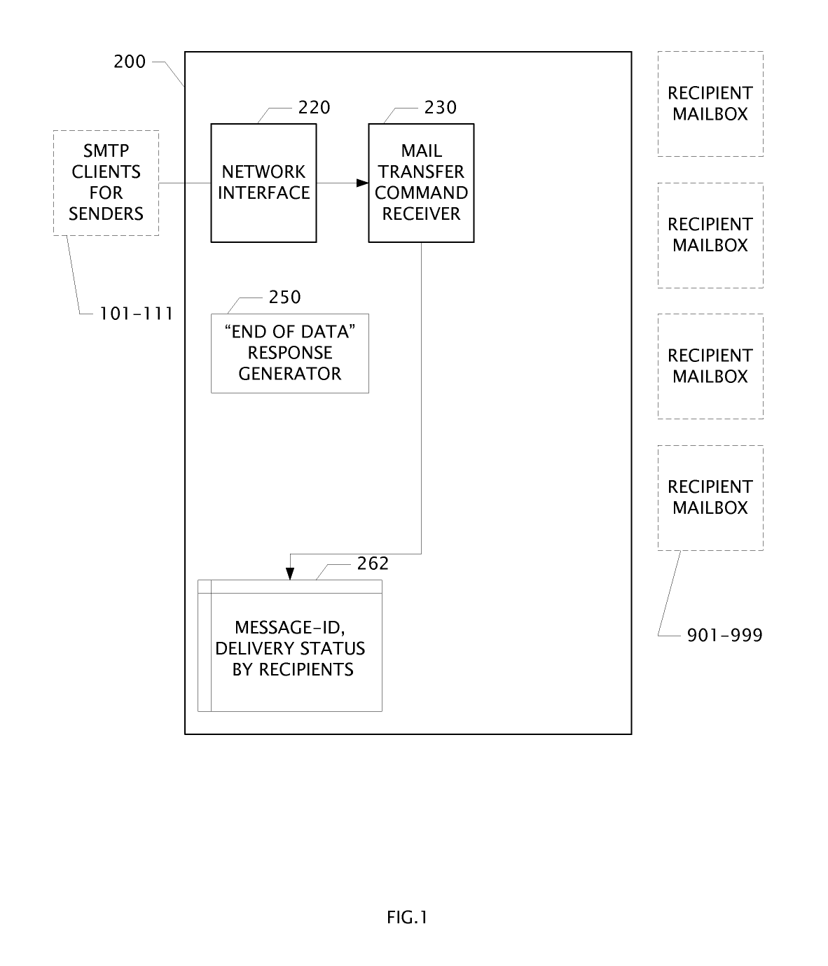

Referring now to FIG. 1, an apparatus for providing mail transfer 200 is communicatively coupled to at least one simple mail transfer protocol client 101-111 for senders of electronic mail and further communicatively coupled to a plurality of recipient mailboxes 901-999 to which the one or more clients are transmitting electronic mail addressed to more than one recipient. Apparatus 200 comprises a network interface 220 communicatively coupled to the one or more clients coupled through a network. The apparatus further comprises a mail transfer command receiver 230 said receiver comprising a circuit configured to receive and process selected known simple mail transfer protocol (SMTP) commands including but not limited to HELO, EHLO, MAIL, RCPT, DATA. It is known that the RCPT command is repeated for a plurality of recipients and that the DATA command is followed by the body of the email as well as a globally unique message-id which is all received by the mail transfer command receiver followed by the well known “end of data” sequence. The apparatus further comprises an “end of data” response generator 250 which determines a reply code. The apparatus further comprises a data store 262 containing message-memorandum, in an embodiment message-id's, and their delivery status by recipients. Querying the memorandum store determines which if any of the intended recipients identified in the current mail transaction have a delivery status of success for this message-memorandum.

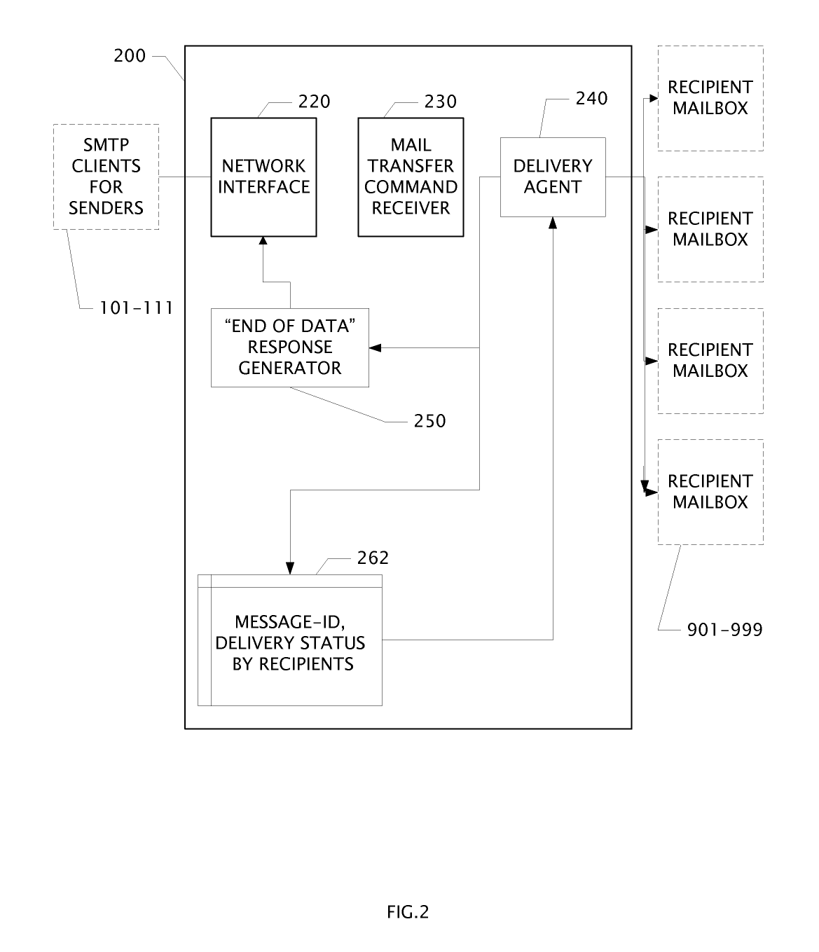

Referring now to FIG. 2, the apparatus further comprises a delivery agent circuit 240 which is communicatively coupled to a plurality of recipient mailboxes and can determine if an email address is transiently or permanently not available. When the mail transfer command receiver receives an email for which not all of the recipients have already a success status, the delivery agent will attempt to deliver to the recipient mailboxes which not received said email and subsequently update the current message-memorandum, delivery status by recipient store 262. A failure reply code will be generated by the “end of data” response generator in the event that at least one of the recipients is either transiently or permanently not available. When at least one of the recipients is transiently not available and at least one of the recipients is permanently not available, a transient fail code is generated in a first embodiment.

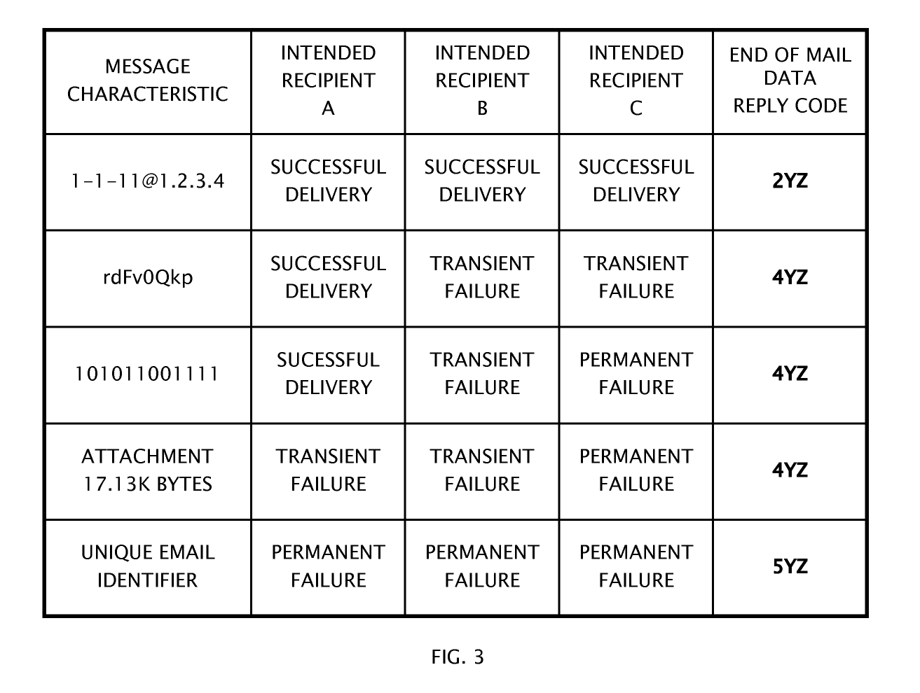

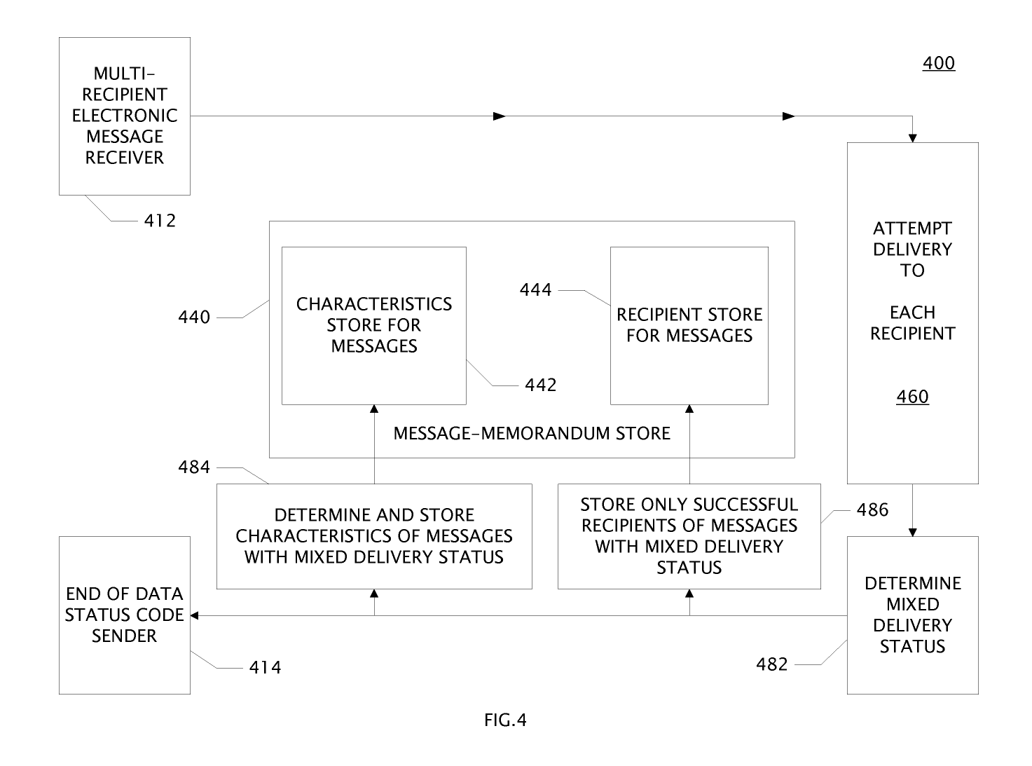

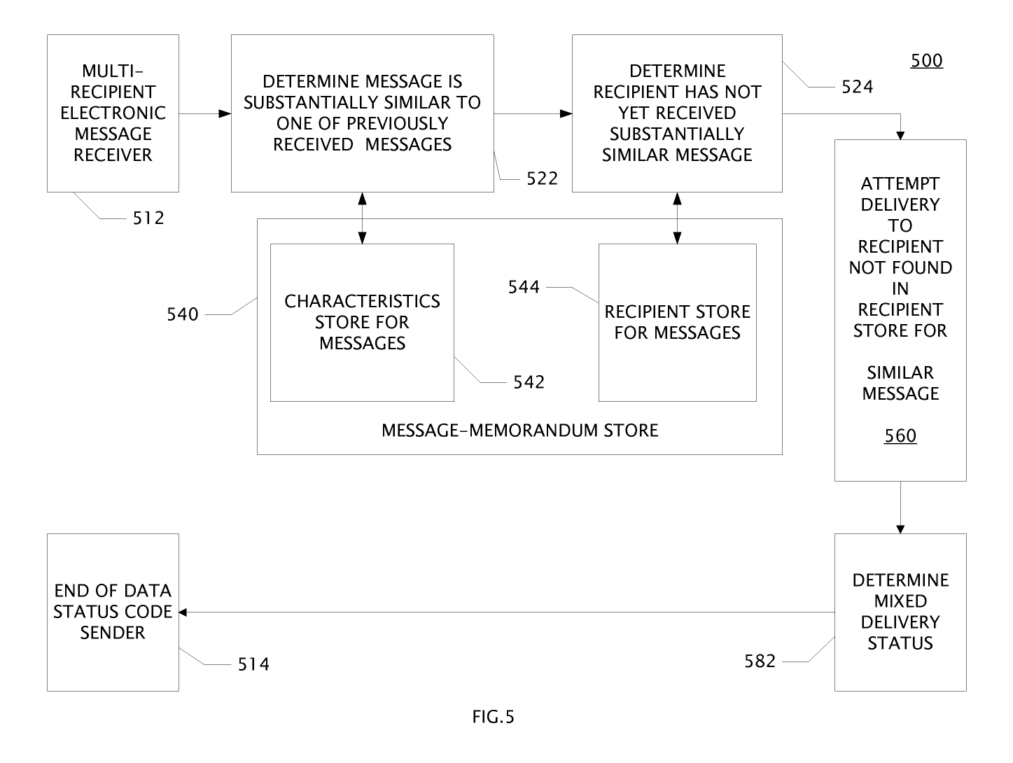

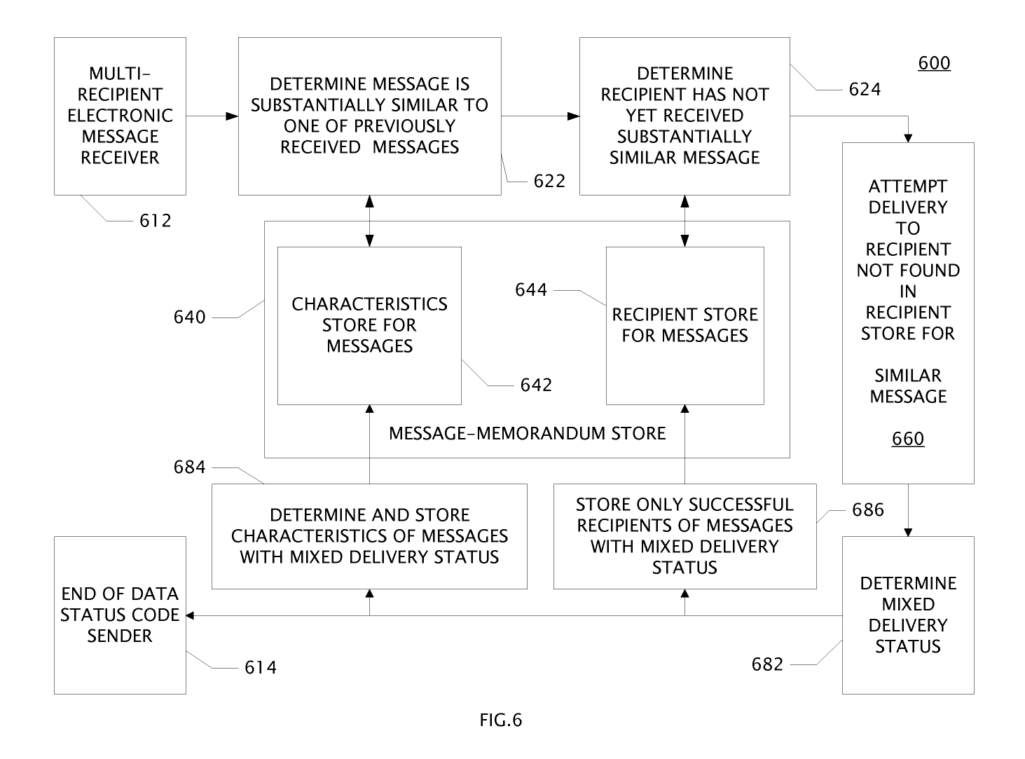

FIG. 3 is a table illustrating interesting aspects of storing into the message-memorandum store and the determination of reply code responses to the end of mail data indication. The right hand columns show for a plurality of intended recipients the reply codes which distinguish the present invention. It is conventional in the cases of uniform delivery status for all intended recipients, i.e. all success, all temporary failure, all permanent failure, that the reply code reflect 2yz, 4yz, and 5yz respectively. What is disclosed herein is the reply code to mixed delivery status in order to encourage retry without additional human intervention. When delivery to any one or more of the intended recipients is a temporary failure, the reply code is of type temporary failure, 4yz. In an embodiment when the combination is of success and permanent failure the reply code is success and in an other embodiment the reply code is permanent failure because no retry is encouraged. A human readable text may be appended after the reply code to identify individual delivery success or failure.

The left most column of the table of FIG. 3 illustrates examples of message characteristics which are stored into the message-memorandum store along with the recipients to whom the message was successfully delivered. In embodiments, the recipients for whom delivery was not successful may be also stored. The objective of the invention is to minimize duplicate delivery of a substantially similar message. In one embodiment the characteristic and each successful recipient are hashed together and the hash is used as an index to a memory. In one embodiment, a message-id is used. But there is no guarantee that the hoped for globally unique message-id is truly globally unique. And it is unnecessary to the objective of this invention to record successful delivery for all time so a globally unique message-id may be undesired even if possible. And messages may be trivially different while being substantially similar by having headers or footers that reflect aspects of the routing through servers in the TCP/IP Internet. Checksums or hashes can be used after discarding these essentially random aspects. The size of the attachments or the size of the message body without the keyword prefixes or suffixes may be used. In short, if a plurality of characteristics is stored for each message, a match with all characteristics is unnecessary to eliminate duplication of substantially similar messages. It is unnecessary to record characteristics for messages which were successful or failure for all intended recipients because such messages should not be resent.

FIG. 4 illustrates components and operation of an embodiment of the apparatus. The receiver 412 operates on a series of commands and data which include recipients and the mail data. A delivery circuit 460 attempts delivery to each of the intended recipients. A circuit 482 to determine mixed delivery status observes delivery status to each of the intended recipients and if all are successful, an end of data status code sender circuit provides a success reply code. However, when delivery to all of the intended recipients is not successful, a failure type of reply code is generated such as illustrated in table 3 above. In that event, a circuit 484 determines a characteristic for the message and stores it into a characteristics store 442. In an embodiment, a circuit 486 stores only the recipients to whom the message was successfully delivered into a recipient store 444.

FIG. 5 illustrates components and operation of an other embodiment. After receiving a multi-recipient electronic message in a receiver 512, a circuit 522 determines that the current message is substantially similar to one of the previously received messages by comparison with characteristics in the message memorandum 540. For each intended recipient, a circuit 524 determines if said recipient has or has not received a substantially similar message. Duplicates are dropped. A delivery circuit 560 attempts delivery only to each recipient who has not received a substantially similar message. In the event that delivery to all intended recipients is now successful, the circuit 582 to determine mixed delivery status allows the end of data status code sender to transmit a success reply code.

Referring now to FIG. 6, an other embodiment comprises an apparatus 600, comprising:
a message-memorandum store 640,
   comprising characteristics store 642 for each message, and
   a list store 644 of recipients who have successfully received each message;
a circuit to receive electronic messages intended for a plurality of intended recipients 612,
   which includes a circuit 614 for transmitting a status code after receiving the end of data sequence;
a circuit to determine if a message is substantially similar 622 to a previously received message whose recipients are in the list store,
   coupled to the circuit to receive electronic messages 612 and coupled to the message-memorandum store 640;
a circuit to attempt transmission 660 to an intended recipient not in the list store of a message substantially similar to a previously received message whose recipients are in the list store,
   coupled to a circuit to determine 624 if an intended recipient is in the list store;
a circuit to determining a message delivery status 682 of mixed status if a message delivery to a plurality of intended recipients has at least one success status with respect to the intended recipients and at least one temporary failure status with respect to the intended recipients,
   coupled to the circuit to attempt transmission 660 and
   coupled to the circuit for transmitting a status code 614;
a circuit to store characteristics of each message 684 which was intended to a plurality of recipients and was delivered successfully to at least one recipient and was not delivered successfully to at least one other recipient,
   coupled to the characteristic store 642, and
   coupled to the circuit to determine 682 message delivery status of mixed status;
a circuit to store 686 into a list store the intended recipients of a message with mixed status to whom the delivery was successful,
   coupled to the list store 644, and
   coupled to the circuit to determine message delivery status 682.

The receiving/relay system would repeat this process until all recipients had been allowed. In an embodiment if several recipients are always deferred in each attempt, the sending system would eventually give up based on an implementation-specific timeout and would probably relay the partial 4yz message to the sender. In an embodiment, the receiving/relay system could expire the persistent entries after a reasonable interval of time.

An apparatus embodiment comprises:
a circuit to receive electronic messages intended for a plurality of recipients and to respond to an end of data sequence with a type of SMTP reply code when delivery status was mixed, coupled to
a circuit to determine a delivery status of mixed when delivery was successful to at least one of the intended recipients and was not successful to at least one other of the intended recipients.

In an embodiment the apparatus further comprises:
a circuit to store recipients and characteristics of messages with a mixed delivery status into a message-memorandum store, coupled to the circuit to determine a delivery status;
the circuit to determine delivery status further coupled to
a circuit to attempt transmission to intended recipients of a message not having previously received a substantially similar message; coupled to
a circuit for determining if an intended recipient had previously received a substantially similar message by reading recipients and characteristics from the message-memorandum store.

In an embodiment the apparatus further comprises:
a message-memorandum store comprising
   a message characteristic store and
   a message recipient store coupled to the circuits to read and store recipients and characteristics of a message which was successfully delivered to at least one of the intended recipients and was not successfully delivered to at least one other of the intended recipients.

An apparatus embodiment comprises a processor coupled to
a message-memorandum store;
a circuit to receive electronic messages intended for a plurality of intended recipients; and
a circuit to determine if a message is substantially similar to a previously received message,

coupled to the circuit to receive electronic messages and coupled to the message-memorandum store.

In an embodiment the message-memorandum store comprises
a characteristic store for each message, and
a list store of recipients who have successfully received each message.

In an embodiment the circuit to receive electronic messages intended for a plurality of intended recipients comprises,
a circuit for transmitting a reply code after receiving the end of data indication sequence.

In an embodiment the apparatus further comprises:
a circuit to attempt transmission to an intended recipient not in the list store of a message substantially similar to a previously received message whose recipients are in the list store,
   coupled to a circuit to determine if an intended recipient is in the list store.

In an embodiment the apparatus further comprises:
a circuit to determine a message delivery status of mixed status if a message delivery to a plurality of intended recipients has at least one success status with respect to the intended recipients and at least one temporary failure status with respect to the intended recipients,
   coupled to the circuit to attempt transmission and
   coupled to the circuit to the circuit for transmitting a reply code.

In an embodiment the apparatus further comprises:
a circuit to store characteristics of each message which was intended to a plurality of recipients and was delivered successfully to at least one recipient and was not delivered successfully to at least one other recipient,
   coupled to the characteristic store, and
   coupled to the circuit to determine message delivery status of mixed status; and
a circuit to store into a list store the intended recipients of a message with mixed status to whom the delivery was successful,
   coupled to the list store, and
   coupled to the circuit to determine message delivery status.

A system to handle mail as a cloud service comprises a hardware server coupled by a network interface to a wide area network and further coupled to a plurality of local or remote mail transfer agents, circuits to determine if an incoming electronic mail addressed to a plurality of intended recipients is substantially similar to a previous message which was successfully delivered to at least one of but fewer than all of the previously intended recipients, and to attempt delivery without duplication, and to respond to the email sender's end of data sequence with a reply code of type failure when delivery is successful to at least one of but fewer than all of the intended recipients.

A computer-implemented method embodiment comprises
attempting to deliver an electronic message to a plurality of intended recipients prior to completing a DATA command dialog with a reply code;
responding to an end of mail data indication sequence with a reply code of type transient failure on the condition that delivery to one or more of the intended recipients was a transient failure; and
storing into a memorandum store at least a message-memorandum for each intended recipient whose delivery was successful. In an embodiment, a record is kept for each intended recipient for which delivery of a message is a permanent failure.

In an embodiment, attempting to deliver an electronic message to a plurality of intended recipients prior to completing a data command sequence with a reply code comprises
performing recipient verification and
passing each message to a Mail User Agent for each intended recipient before accepting the end of the mail data. Said Mail User Agent may be local or remote to the server and may be contacted via a remote server.

An other embodiment of the above method further comprises the step
depositing the message in a message store.

An other embodiment of the above method further comprises the step
determining when a condition of transient failure occurs before returning a 250 OK reply to the end of mail data sequence whereby the server is not configured to accept a message for future delivery.

In an embodiment, responding to an end of mail data sequence with a reply code of transient failure on the condition that delivery to one or more of the intended recipients was a transient failure comprises:
determining a message delivery status for each of the intended recipients after the receipt of an end of mail data sequence but prior to the transmission of a reply code to complete the DATA command dialog.

In an embodiment, the message delivery status for each of the intended recipients is selected from the following group: success, transient failure, and permanent failure.

An other embodiment of the above method further comprises the step
responding to the end of mail data sequence with a reply of transient failure followed by a text message comprised of at least one of the following:
   the recipients for whom the message delivery status was success,
   the recipients for whom the message delivery status was transient failure, and
   the recipients for whom the message delivery status was permanent failure.

In an embodiment, storing into a memorandum store at least a message-memorandum for each intended recipient whose delivery was successful comprises
when the reply code to an end of mail data sequence is a transient failure reply code,
determining to which of the intended recipients the message delivery was successful.

An other embodiment of the above method further comprises the step
determining a message-memorandum for each successfully delivered message comprising a hash of a message-id and the recipient address.

An other embodiment of the above method further comprises the step
storing into a computer-readable memorandum store a record of the successful delivery of a message to a recipient whereby a subsequent resending of the identical message to the recipient can be detected and duplicate delivery avoided.

An other computer-implemented method embodiment for improved efficiency in handling electronic mail destined for recipients comprises
when an electronic mail session comprises a plurality of recipient commands:
   determining a message-memorandum,
   checking a memorandum store to determine the likelihood that the recipient has successfully received a substantially similar electronic mail,
   disposing of the electronic mail,
   determining a reply code, and
   responding to an end of mail data indication.

In an embodiment, determining a reply code comprises: when delivery to at least one of the recipients is a transient failure, selecting a Transient Negative Completion reply code.

In an embodiment, a transient negative completion code comprises a 4 as the initial digit whereby a client apparatus may automatically determine to retry the transmission at a later time without human intervention.

In an embodiment, determining a message-memorandum for each of the recipients comprises:
reading the message-id,
reading the recipient address, and
combining the message-id and the recipient address.

In an embodiment, determining a message-memorandum for each of the recipients comprises
reading the message-id
reading the recipient address, and
hashing the message-id and the recipient address.

In an embodiment which is illustrative and non-limiting, determining a message-memorandum for each of the recipients comprises, hashing the mail data. In an embodiment which is illustrative and non-limiting, determining a message-memorandum for each of the recipients comprises:
hashing an attachment to an electronic mail. In an embodiment which is illustrative and non-limiting, determining a message-memorandum for each of the recipients comprises computing a checksum of the message-id and the recipient address. In an embodiment which is illustrative and non-limiting, determining a message-memorandum for each of the recipients comprises; deleting incidental portions of the portions such as headers, footers, keywords, and tcp/ip routing history; and computing a checksum of body of the data portion of the electronic mail session.

In an embodiment, checking a memorandum store to determine the likelihood that the recipient has successfully received the electronic mail comprises:
querying a memorandum store with a message-memorandum, and at least one of
a. determining that a message-memorandum is not found in the memorandum store,
b. reading from the memorandum store a delivery status for a message-memorandum for at least one recipient.

In an embodiment, disposing of the electronic mail comprises
when the memorandum store indicates the condition that the recipient has likely successfully received the electronic mail,
dropping the electronic mail to that recipient;
when the memorandum store indicates the condition that the recipient has likely not successfully received the electronic mail,
delivering the electronic mail and
storing the message memorandum and the delivery status in the memorandum store wherein
delivery status is one of success and failure.

An other embodiment of the above method further comprises the step
when the memorandum store indicates the condition that the recipient has likely permanently failed to receive the electronic mail,
dropping the electronic mail to that recipient.

In an embodiment, responding to an end of mail data indication comprises:
sending the reply code and
a text string comprising at least one of the following
   1. a list of intended recipients with successful delivery status,
   2. a list of intended recipients with transient failure delivery status, and
   3. a list of intended recipients with permanent failure delivery status.

In an embodiment, the end of mail data indication is determined by a response to a DATA command. In an other embodiment, the end of mail data indication is an end of data sequence. In an other embodiment, the end of mail data indication comprises the five characters:
carriage return,
line feed,
period,
carriage return,
line feed, in that order.

An apparatus comprises a network interface, coupled to a mail transfer command receiver, coupled to an “end of data” response generator, coupled to a data store, and a delivery agent communicatively coupled to a plurality of recipient mailboxes.

In an embodiment the data store contains message-memorandum, including delivery status to each intended recipient.

In an embodiment the “end of data” response generator comprises a circuit to generate a transient failure code when any one of the mailboxes intended recipients is either transiently or permanently not available.

A computer-implemented method embodiment for operating an email server comprises:
receiving at least a first recipient and a second recipient;
receiving DATA and an “end of data” sequence;
determining the email delivery status for each recipient from among the following:
   success,
   persistent transient failure, and
   permanent failure;
transmitting a persistent transient failure reply code in response to the “end of data” sequence when the email delivery status for the respective recipients are success and persistent transient failure;
transmitting a permanent failure reply code in response to the “end of data” sequence when the email delivery status for the respective recipients are success and permanent failure; and
transmitting a success reply code in response to the “end of data” sequence when the email delivery status for the respective recipients are success and success.

In an embodiment the method further comprising transmitting a persistent transient failure reply code in response to the “end of data” sequence when the email delivery status for the respective recipients are persistent transient failure and permanent failure.

In an embodiment the method further comprising transmitting a permanent failure reply code in response to the “end of data” sequence when the email delivery status for the respective recipients are persistent transient failure and permanent failure.

A computer-implemented method for operating an electronic mail server comprises:
receiving a plurality of recipients in an SMTP mail session;
receiving DATA and an “end of data” sequence;
determining the email delivery status for each recipient from among the following:
i. success,
ii. persistent transient failure, and
iii. permanent failure;
   transmitting a persistent transient failure reply code in response to the “end of data” sequence when the email delivery status for the recipients comprise no permanent failures and at least one persistent transient failure; and
   transmitting a success reply code in response to the “end of data” sequence when the email delivery status for the recipients are selected from the following: success and not any other status.

In an embodiment the method further comprising transmitting a persistent transient failure reply code in response to the “end of data” sequence when the email delivery status for the recipients are at least one persistent transient failure and at least one permanent failure.

In an embodiment the method further comprising storing a globally unique email identifier and delivery status for each recipient for each email for which the server determines a persistent transient failure delivery status at the “end of DATA” sequence.

In an embodiment the method further comprising
receiving a MAIL command, a message-memorandum, and at least one RCPT,
determining if the recipient does not have a success for the message-memorandum, and
transmitting the message to the recipient if the message has not yet been successfully transmitted to the recipient.

A software program product tangibly embodied on a computer-readable storage device encoded with computer executable instructions to
receive simple mail transfer protocol commands,
check a database for delivery status of a message-id to each of a plurality of recipients,
deliver the message to available recipients which have not yet received the message,
update the database with the current status of message delivery, and
respond to an “end of data” sequence with a status code derived from the combination of status of delivery to each recipient.

### CONCLUSION

The present invention is easily distinguished from conventional mail transfer solutions by not sending negative delivery reports which contribute to spam, by not accepting mail for delivery and signaling success when it cannot be determined, by not sending duplicates to recipients who were successful in receiving an email that was deferred or rejected by other recipients, and by sending a list of the successes or fails for each recipient as supplemental information with the status code.

Although specific protocols have been used to describe embodiments, other embodiments can use other transmission protocols or standards. Use of the terms ‘store’, ‘circuit’, and ‘server’ can include any type of device, operation, or other process. The present invention can operate between any two processes or entities including users, devices, functional systems, or combinations of hardware and software.

Other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, or transport the computer program for use by or in connection with the instruction execution system apparatus, system or device. The computer readable medium can be, by way of example only but not by limitation, an chemical, electronic, magnetic, optical, electromagnetic, infrared, or semiconductor system, apparatus, system, device, material, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

The scope of the invention includes all modification, design variations, combinations, and equivalents that would be apparent to persons skilled in the art, and the preceding description of the invention and its preferred embodiments is not to be construed as exclusive of such.

What is claimed is:

1. An apparatus comprising:
a circuit to receive electronic messages intended for a plurality of recipients and to respond to an end of data sequence with a type of SMTP status code when delivery status was mixed, coupled to
a circuit to determine a delivery status of mixed when delivery was successful to at least one of the intended recipients and was not successful to at least one other of the intended recipients.

2. The apparatus of claim 1 further comprising
a circuit to store recipients and characteristics of messages with a mixed delivery status into a message-memorandum store, coupled to the circuit to determine a delivery status;
the circuit to determine delivery status further coupled to a circuit to attempt transmission to intended recipients of a message not having previously received a substantially similar message; coupled to
a circuit for determining if an intended recipient had previously received a substantially similar message by reading recipients and characteristics from the message-memorandum store.

3. The apparatus of claim 1 further comprising
a message-memorandum store comprising
a message characteristic store and
a message recipient store coupled to the circuits to read and store recipients and characteristics of a message which was successfully delivered to at least one of the intended recipients and was not successfully delivered to at least one other of the intended recipients.

4. An apparatus comprising:
a processor; coupled to
a message-memorandum store;
a circuit to receive electronic messages intended for a plurality of intended recipients;
a circuit to determine if a message is substantially similar to a previously received message,
coupled to the circuit to receive electronic messages and
coupled to the message-memorandum store.

5. The apparatus of claim 4 wherein the message-memorandum store comprises:
a characteristic store for each message, and
a list store of recipients who have successfully received each message.

6. The apparatus of claim 4 wherein the circuit to receive electronic messages intended for a plurality of intended recipients comprises,
a circuit for transmitting a status code after receiving the end of data sequence.

7. The apparatus of claim 4 further comprising
a circuit to attempt transmission to an intended recipient not in the list store of a message substantially similar to a previously received message whose recipients are in the list store,
coupled to
a circuit to determine if an intended recipient is in the list store.

8. The apparatus of claim 4 further comprising
a circuit to determine a message delivery status of mixed status if a message delivery to a plurality of intended recipients has at least one success status with respect to the intended recipients and at least one temporary failure status with respect to the intended recipients,
coupled to the circuit to attempt transmission and
coupled to the circuit to the circuit for transmitting a status code.

9. The apparatus of claim 4 further comprising:
a circuit to store characteristics of each message which was intended to a plurality of recipients and was delivered successfully to at least one recipient and was not delivered successfully to at least one other recipient,
coupled to the characteristic store, and
coupled to the circuit to determine message delivery status of mixed status; and
a circuit to store into a list store the intended recipients of a message with mixed status to whom the delivery was successful,
coupled to the list store, and
coupled to the circuit to determine message delivery status.

10. A system to handle mail as a cloud service comprising a hardware server coupled by a network interface to a wide area network and further coupled to a plurality of local or remote mail transfer agents determine if an incoming electronic mail addressed to a plurality of intended recipients is substantially similar to a previous message which was successfully delivered to at least one of but fewer than all of the previously intended recipients, and attempt delivery without duplication, and respond to the email sender's end of data sequence with a reply code of type failure when delivery is successful to at least one of but fewer than all of the intended recipients.

11. A computer-implemented method comprising
attempting to deliver an electronic message to a plurality of intended recipients prior to completing a DATA command dialog with a reply code;
responding to an end of mail data sequence with a reply code of transient failure on the condition that delivery to one or more of the intended recipients was a transient failure; and
storing into a memorandum store at least a message-memorandum for each intended recipient whose delivery was successful.

12. The computer-implemented method of claim 11 wherein attempting to deliver an electronic message to a plurality of intended recipients prior to completing a data command sequence with a reply code comprises the steps following:
performing recipient verification, and
passing each message to a Mail User Agent for each intended recipient before accepting the end of the mail data.

13. The method of claim 12 further comprising
depositing the message in a message store.

14. The method of claim 12 further comprising
determining when a condition of transient failure occurs before returning a 250 OK reply to the end of mail data sequence whereby the server is not configured to accept a message for future delivery.

15. The computer-implemented method of claim 11 wherein
responding to an end of mail data sequence with a reply code of transient failure on the condition that delivery to one or more of the intended recipients was a transient failure comprises
determining a message delivery status for each of the intended recipients after the receipt of an end of mail data sequence but prior to the transmission of a reply code to complete the DATA command dialog.

16. The method of claim 15 wherein the message delivery status for each of the intended recipients is selected from the following group: success, transient failure, and permanent failure.

17. The method of claim 16 further comprising:
responding to the end of mail data sequence with a reply of transient failure followed by a text message comprising at least one of the following:
the recipients for whom the message status was success,
the recipients for whom the message status was transient failure, and
the recipients for whom the message status was permanent failure.

18. The computer-implemented method of claim 11 wherein
storing into a memorandum store at least a message-memorandum for each intended recipient whose delivery was successful comprises:
when the reply code to an end of mail data sequence is a transient failure reply code, determining to which of the intended recipients the message delivery was successful.

19. The method of claim 18 further comprising
determining a message-memorandum for each successfully delivered message comprising a hash of a message-id and the recipient address.

20. The method of claim 18 further comprising
storing into a computer-readable memorandum store a record of the successful delivery of a message to a recipient whereby a subsequent resending of the identical message to the recipient can be detected and duplicate delivery avoided.

21. A computer-implemented method for improved efficiency in handling electronic mail destined for recipients comprising
when an electronic mail session comprises a plurality of recipient commands:
determining a message-memorandum,
checking a memorandum store to determine the likelihood that the recipient has successfully received a substantially similar electronic mail,
disposing of the electronic mail,
determining a reply code, and
responding to an end of mail data indication.

22. The method of claim 21 wherein determining a reply code comprises
when delivery to at least one of the recipients is a transient failure,
selecting a Transient Negative Completion reply code.

23. The method of claim 22 for determining a reply code wherein a transient negative completion reply code comprises a 4 as the initial digit whereby a client apparatus may automatically determine to retry the transmission at a later time without human intervention.

24. The method of claim 21 wherein determining a message-memorandum for each of the recipients comprises
reading the message-id,
reading the recipient address, and
combining the message-id and the recipient address.

25. The method of claim 21 wherein determining a message-memorandum for each of the recipients comprises:
reading the message-id,
reading the recipient address, and
hashing the message-id and the recipient address.

26. The method of claim 21 wherein determining a message-memorandum for each of the recipients comprises,
hashing some or all of the mail data.

27. The method of claim 21 wherein determining a message-memorandum for each of the recipients comprises,
hashing an attachment to an electronic mail.

28. The method of claim 21 wherein determining a message-memorandum for each of the recipients comprises
computing a checksum of the message-id and the recipient address.

29. The method of claim 21 wherein determining a message-memorandum for each of the recipients comprises, computing a checksum of the data portion of the electronic mail session.

30. The method of claim 21 wherein
checking a memorandum store to determine the likelihood that the recipient has successfully received the electronic mail comprises:
querying a memorandum store with a message-memorandum, and at least one of
determining that a message-memorandum is not found in the memorandum store,
reading from the memorandum store a delivery status for a message-memorandum for at least one recipient.

31. The method of claim 21 wherein disposing of the electronic mail comprises
when the memorandum store indicates the condition that the recipient has likely successfully received the electronic mail,
dropping the electronic mail to that recipient;
when the memorandum store indicates the condition that the recipient has likely not successfully received the electronic mail,
delivering the electronic mail and
storing the message memorandum and the delivery status in the memorandum store wherein
delivery status is one of success and failure.

32. The method of claim 31 further comprising the step:
when the memorandum store indicates the condition that the recipient has likely permanently failed to receive the electronic mail,
dropping the electronic mail to that recipient;

33. The method of claim 21 wherein responding to an end of mail data indication comprises the steps following:
sending the reply code; and a text string, the text string comprising at least one of the following
a list of intended recipients with successful delivery status,
a list of intended recipients with transient failure delivery status, and
a list of intended recipients with permanent failure delivery status.

34. The method of claim 33 wherein
the end of mail data indication is determined by a response to a DATA command.

35. The method of claim 33 wherein
the end of mail data indication is an end of data sequence.

36. The method of claim 33 wherein
the end of mail data indication comprises the five characters:
carriage return,
line feed,
period,
carriage return,
line feed, in that order.

37. An apparatus comprises
a network interface, coupled to
a mail transfer command receiver, coupled to
an “end of data” response generator, coupled to
a data store, and
a delivery agent communicatively coupled to a plurality of recipient mailboxes.

38. The apparatus of claim 37 wherein the data store contains message-memorandum, and their delivery status to each intended recipient.

39. The apparatus of claim 37 wherein the “end of data” response generator comprises
a circuit to generate a transient failure code when any one of the mailboxes intended recipients is either transiently or permanently not available.

40. A computer-implemented method for operating an email server comprising the steps following:
receiving at least a first recipient and a second recipient;
receiving DATA and an “end of data” sequence;
determining the email status for each recipient from among the following:
success,
persistent transient failure, and
permanent failure;
transmitting a persistent transient failure code in response to the “end of data” sequence when the email delivery status for the respective recipients are one of success and persistent transient failure;
transmitting a permanent failure code in response to the “end of data” sequence when the email delivery status for the respective recipients one of are success and permanent failure; and
transmitting a success code in response to the “end of data” sequence when the email status for the respective recipients uniformly successful.

41. The method of claim 40 further comprising
transmitting a persistent transient failure code in response to the “end of data” sequence when the email status for the respective recipients are one of persistent transient failure and permanent failure.

42. The method of claim 40 further comprising
transmitting a permanent failure code in response to the “end of data” sequence when the email status for the respective recipients are one of persistent transient failure and permanent failure.

43. A computer-implemented method for operating an electronic mail server comprising the steps following:
receiving a plurality of recipients in an SMTP mail session;
receiving DATA and an “end of data” sequence;
determining the email delivery status for each recipient from among the following:
success,
persistent transient failure, and
permanent failure;
transmitting a persistent transient failure reply code in response to the “end of data” sequence when the email status for the recipients comprise no permanent failures and at least one persistent transient failure; and
transmitting a success reply code in response to the “end of data” sequence when the email delivery status for the recipients are uniformly successful.

44. The method of claim 43 further comprising
transmitting a persistent transient failure code in response to the “end of data” sequence when the email status for the recipients are at least one persistent transient failure and at least one permanent failure.

45. The method of claim 43 further comprising
storing a globally unique email identifier and delivery status for each recipient for each email for which the server determines a persistent transient failure status at the “end of DATA” sequence.

46. The method of claim 45 further comprising
receiving a MAIL command, a message-memorandum, and at least one RCPT,
determining when the recipient does not have a success for the message-memorandum, and
transmitting the message to the recipient when the message has not yet been successfully transmitted to the recipient.

47. A software program product tangibly embodied on a non-transitory computer-readable storage device encoded with computer executable instructions:
to receive simple mail transfer protocol commands,
to check a database for delivery status of a message-id to each of a plurality of recipients,
to deliver the message to available recipients which have not yet received the message,
to update the database with the current status of message delivery, and
to respond to an “end of data” sequence with a status code derived from the combination of status of delivery to each recipient.
